(19) United States
(12) Patent Application Publication
(10) Pub. No.: US 2008/0127043 A1
(43) Pub. Date: May 29, 2008

(54) Automatic Extraction of Programming Rules

(76) Inventors: Yuanyuan Zhou, Champaign, IL (US); Zhenmin Li, Urbana, IL (US)

Correspondence Address: LEE & HAYES, PLLC, 421 W. RIVERSIDE AVE, STE 500, SPOKANE, WA, 99201, US

(21) Appl. No.: 11/468,589

(22) Filed: Aug. 30, 2006

(51) Int. Cl. G06F 9/44; G06F 11/36

(52) U.S. Cl. 717/104; 717/124

(57) ABSTRACT

In accordance with certain aspects of the automatic extraction of programming rules, a plurality of portions of a program are identified. A plurality of sets of numeric values are obtained by generating, for each of the plurality of portions, a set of numeric values that represents the portion. The plurality of sets of numeric values are analyzed to identify programming patterns, and a plurality of programming rules are generated from the programming patterns.

### STATEMENT REGARDING FEDERALLY SPONSORED RESEARCH OR DEVELOPMENT

This invention was made with Government support under Contract Number CCR-0325603 and Contract Number CNS-0347854, both awarded by the National Science Foundation (NSF). The Government has certain rights in the invention.

### BACKGROUND

As computer technology has advanced, computer programs have become very large, oftentimes including tens of thousands or even millions of lines of code. Various programming rules are typically followed by programmers when writing such computer programs, but these rules can be so numerous that they are oftentimes not documented by programmers. This can make it difficult for programmers to remember all the rules they are to follow, and can also make it difficult for new programmers to know all the rules they should follow. Accordingly, it would be beneficial to have a way to automatically identify programming rules and detect violation to these rules.

### SUMMARY

Automatic extraction of programming rules and detection of rule violations are discussed herein.

In accordance with certain aspects of the automatic extraction of programming rules, a plurality of portions of a program are identified. A plurality of sets of numeric values are obtained by generating, for each of the plurality of portions, a set of numeric values that represents the portion. The plurality of sets of numeric values are analyzed to identify programming patterns, and a plurality of programming rules are generated from the programming patterns.

In accordance with other aspects of the automatic extraction of programming rules, a plurality of programming rules in the program are automatically identified. A plurality of violations of the plurality of programming rules are detected, and one or more false violations in the plurality of violations are detected. The one or more false violations are removed from the plurality of violations to obtain a plurality of potential errors, and the plurality of potential errors are identified as potential errors in the program.

### BRIEF DESCRIPTION OF THE DRAWINGS

The same numbers are used throughout the document to reference like components and/or features.

FIG. 1 is a block diagram illustrating an example system that automatically extracts programming rules.

FIG. 2 is a flowchart illustrating an example process for automatically extracting programming rules from a computer program and identifying potential bugs in the computer program.

FIG. 3 is a flowchart illustrating an example process for parsing a program into multiple portions and generating hash value itemsets for each portion.

FIG. 4 is a flowchart illustrating an example process for analyzing the itemsets to identify programming patterns.

FIG. 5 is a flowchart illustrating an example process for generating programming rules from the programming patterns.

FIG. 6 is a flowchart illustrating an example process for detecting violations of programming rules.

FIG. 7 is a flowchart illustrating an example process for pruning false violations of programming rules.

FIG. 8 is a flowchart illustrating an example process for ranking the programming rules violations.

FIG. 9 is a block diagram illustrating an example computing device.

### DETAILED DESCRIPTION

Automatic extraction of programming rules is discussed herein. Computer programs are parsed and numeric values representative of portions of the computer programs are generated. Frequent itemset mining is then performed on the resultant numeric values to extract programming rules from the programs without needing any prior knowledge of the programs and without needing any templates that rules should follow. Violations of these automatically extracted rules can also be detected and identified as being possible bugs in the programs.

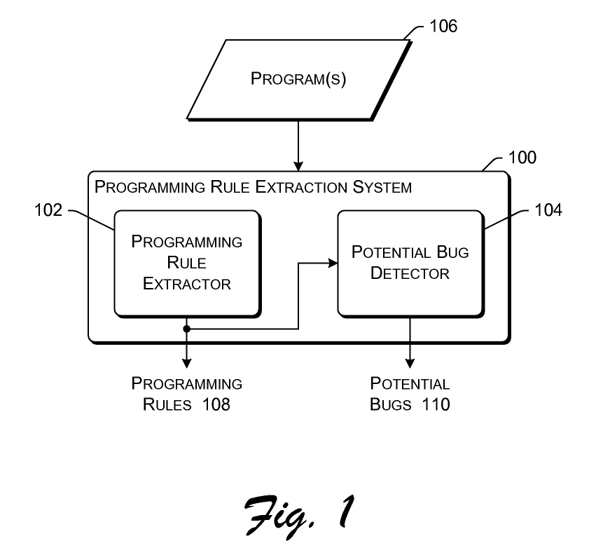

FIG. 1 is a block diagram illustrating an example system 100 that automatically extracts programming rules. Programming rule extraction system 100 includes a programming rule extractor 102 and a potential bug detector 104. One or more programs 106 are obtained by programming rule extraction system 100. Programming rule extractor 102 analyzes each program 106 and extracts programming rules 108 from each program 106. Extracting programming rules from a program 106 refers to identifying programming rules used in program 106.

Extractor 102 extracts programming rules 108 from program(s) 106 without requiring any prior knowledge about program(s) 106 and without requiring any templates that rules in program(s) 106 should follow. Programming rules 108 are output by programming rule extractor 102, and can be used by programmers in any way desired. For example, programming rules 108 can be used to train new programmers, to document the rules that should be followed when creating or modifying program 106, and so forth.

For each program 106, potential bug detector 104 analyzes the program 106 as well as the programming rules for the program 106 as extracted by extractor 102. Based on this analysis, potential bug detector 104 detects portions of the program 106 where the extracted programming rules have not been followed, and identifies those portions as potential bugs or errors 110. The identified potential bugs 110 can be used by programmers in any way desired. For example, programmers can further analyze the potential bugs 110 to determine whether they are actually bugs that should be corrected.

Programming rules refer to particular programming conventions that are followed when writing a program, such as when one particular function is called another particular function should also be called, a call to a particular function should always include a particular set of arguments or parameters, and so forth. For example, one rule may be that when a function “lock” is called then a function “unlock” should also be called. By way of another example, one rule may be that a call to a function “open” should always include a parameter that is a file name of a particular data type.

The programming rules can include any number of function calls, parameters, data types, and so forth. A programming rule may involve only one or two function calls, but may also involve three or more function calls. For example, a particular programming rule may be that a group of seven different function calls should always be called in the same block of code (e.g., in the same function). There is no specific template that all programming rules must follow. Programming rule extractor 102 is not given any template(s) that rules should have. Rather, programming rule extractor 102 can automatically extract rules from programs without any predefined template for the rules.

It should be noted that, although discussions herein may refer to software programs, the automatic extraction of programming rules discussed herein is not limited to software programs. Programming rules from other types of programs, such as firmware programs, can also be extracted using the techniques discussed herein, and potential bugs in such other types of programs can also be identified using the techniques discussed herein.

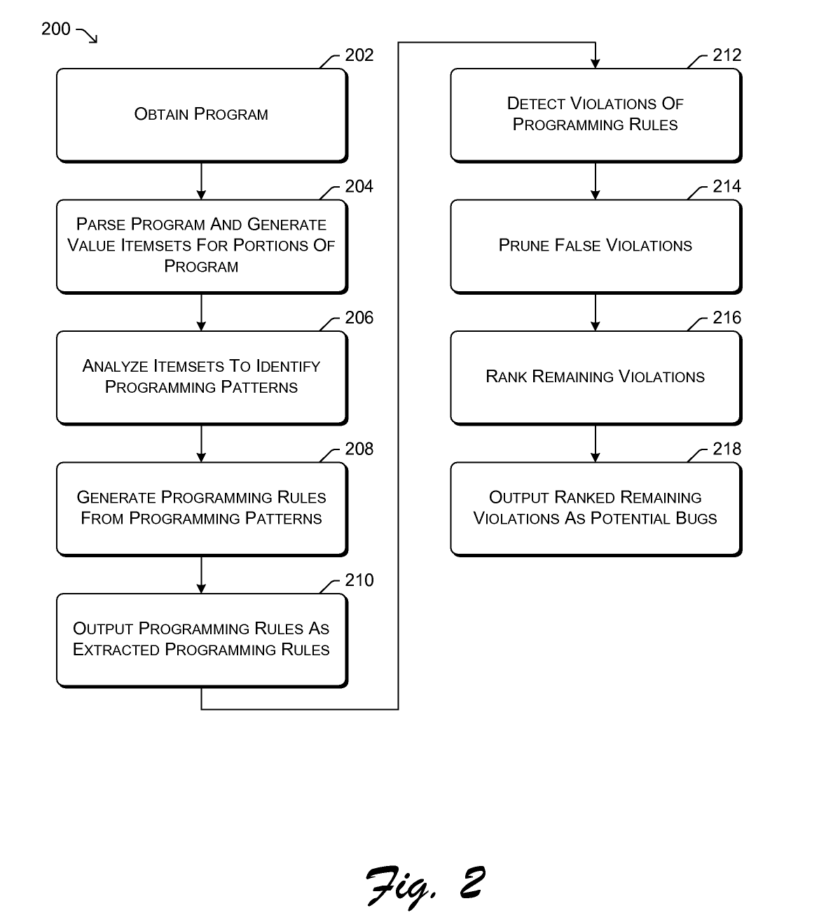

FIG. 2 is a flowchart illustrating an example process 200 for automatically extracting programming rules from a computer program and identifying potential bugs in the computer program. Process 200 is implemented by programming rule extraction system 100 of FIG. 1, and may be performed in software, firmware, hardware, or combinations thereof.

Initially, a computer program is obtained (act 202). The computer program can be passed to extraction system 100, or alternatively extraction system 100 may access the program from a known location (e.g., a default location, or a location identified to extraction system 100). The computer program is then parsed into multiple portions and value itemsets are generated for each portion (act 204). In certain embodiments, each function in the computer program is used as a different portion of the program in act 204. Alternatively, portions can be different parts of the program, such as basic blocks of the program. One or more elements of a function are then mapped to numeric values. In certain embodiments, the numeric values are generated by hashing each of the one or more elements to generate a hash value. The numeric values are combined (e.g., as a set of values) to generate an itemset for that function.

The itemsets generated in act 204 are then analyzed to identify programming patterns (act 206). The analysis in act 204 can be performed in different manners. In certain embodiments, the analysis is performed using a technique referred to as frequent itemset mining. Frequent itemset mining identifies, from a large collection of sets of items (itemsets), itemsets that appear in the collection more than a specified threshold number of times (and thus are referred to as frequent itemsets). From the itemsets generated in act 204, those itemsets that are frequent itemsets are identified as programming patterns in act 206.

Programming rules are then generated from the programming patterns (act 208). A programming pattern can lead to multiple different rules. The programming patterns identify elements that are correlated and used together frequently, but do not themselves identify programming rules. For example, assume that a particular programming pattern is {spin_lock_irqsave, spin_unlock_irqrestore}. Given this programming pattern, two different programming rules may result: (1) spin_lock_irqsave [symbol] spin_unlock_irqrestore, which says that whenever the program calls spin_lock_irqsave it should also call spin_unlock_irqrestore, and (2) spin_unlock_irqrestore [symbol] spin_lock_irqsave, which says that whenever the program calls spin_unlock_irqrestore it should also call spin_lock_irqsave. These are two different rules, and one or both may not hold as programming rules even though the programming pattern may appear many times.

Generally, to generate the programming rules from the programming patterns, for the possible programming rules the number of cases in the program that contain the items on the left but not those on the right are found. Following the preceding example, it is determined how frequently spin_lock_irqsave appears in the program but spin_unlock_irqrestore does not appear in the program, and similarly how frequently spin_unlock_irqrestore appears in the program but spin_lock_irqsave does not appear in the program. Based on these frequencies, a confidence value for each rule can be determined.

Different possible rules that can be generated from a particular programming pattern are analyzed and a confidence value for each rule is generated. The confidence value for a particular rule refers to the probability that the rule is actually a programming rule for the program. These confidence values can be generated in different manners, as discussed in more detail below. Those rules having confidence values that exceed a threshold value are identified as the programming rules in act 208. These identified programming rules are output as the extracted programming rules (act 210).

Violations of the programming rules identified in act 208 can also be detected (act 212). These violations are detected by analyzing the programming rules and identifying, for each programming rule, whether there are any instances in the program where the programming rule is not followed. If there are no such instances, then there is no violation of the programming rule.

False violations from those violations detected in act 212 are then pruned or removed (act 214). False violations are pruned by performing an inter-procedural check of whether the violation actually occurred. In certain embodiments, the violation detection in act 212 is performed on an intra-procedural basis, so that even if the programming rule is satisfied by another procedure or function (e.g., a procedure or function that is called from the function being analyzed), then a violation would be detected in act 212. The procedures or functions that are called from that function in which the violation was detected are checked in act 214 to see if the programming rule is satisfied. If the programming rule is satisfied by another procedure or function, then the violation is pruned from the set of violations in act 214.

The remaining violations after pruning is performed in act 214 are ranked (act 216). A confidence value is generated for each rule indicating how confident the system is that the rule is actually a programming rule. Those violations corresponding to rules having the highest confidence values are ranked the highest, as these have the highest confidence of being bugs in the computer program. The ranked violations are then output as potential bugs or errors in the computer program (act 218).

It should be noted that act 216 is optional and is not performed in certain embodiments. In such embodiments, the violations from act 214 are output as the potential bugs without any ranking. The violations can be output in any order (e.g., in order of appearance in the program, randomly, and so forth).

It should also be noted that the potential bug detection of acts 212-218 is optional and is not performed in certain embodiments. In such embodiments, programming rules are extracted from the program by process 200, but potential bugs in the program are not detected.

It should further be noted that process 200 of FIG. 2 illustrates both program rule extraction and detection of programming rule violations. It is to be appreciated that such extraction and detection can be performed separately, and that each can be performed without the other. For example, programming rule extraction in acts 202-210 can be performed without detecting any violations of any programming rules. By way of another example, potential bug detection in acts 212-218 can be performed when programming rules are extracted in a manner different than that described in acts 202-210.

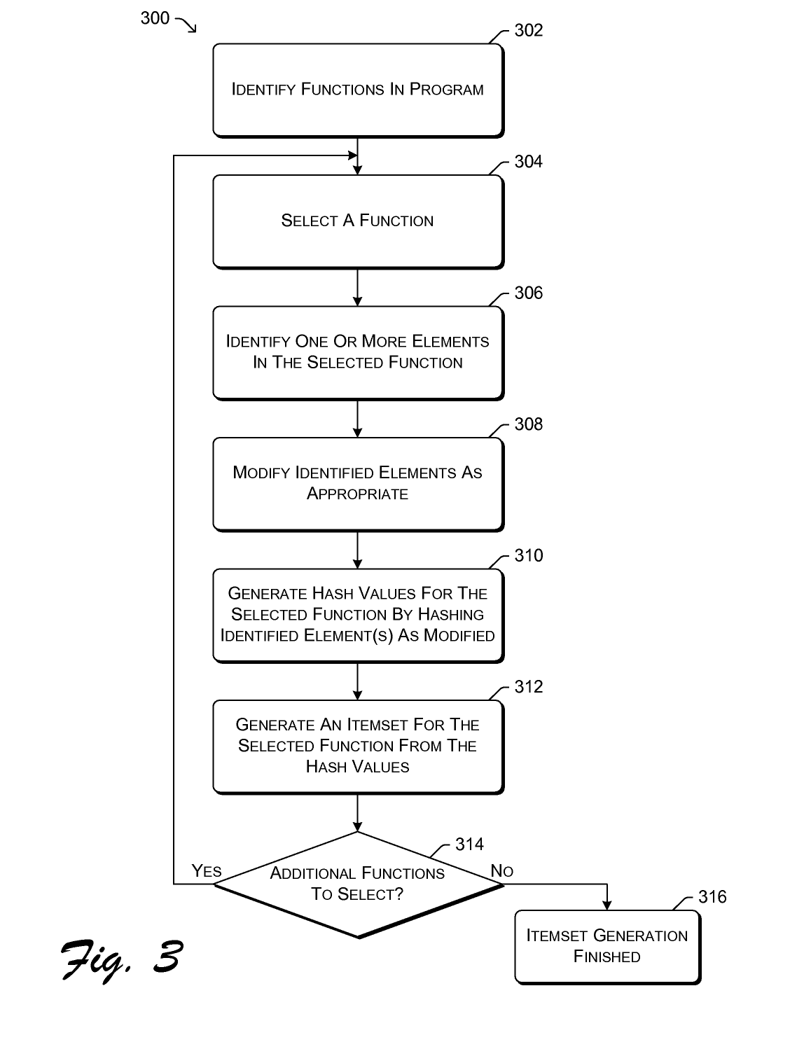

FIG. 3 is a flowchart illustrating an example process 300 for parsing a program into multiple portions and generating hash value itemsets for each portion. Process 300 illustrates an example of the parsing and generating of act 204 of FIG. 2 in additional detail. Process 300 is implemented by programming rule extractor 102 of FIG. 1, and may be performed in software, firmware, hardware, or combinations thereof.

In process 300, the portions of the program are the functions of the program. Initially, the functions in the program are identified (act 302). The functions in the program can be identified in different manners. In certain embodiments, the program is converted into an intermediate representation that is stored in a tree data structure. Each node in the tree data structure represents an element in the program, such as an identifier name, a data type name, a keyword, an operator, a control structure, and so forth. This intermediate representation can be obtained in different well-known manners, such as by using the front end of the GNU compiler collection (GCC). The appropriate GCC front end for the programming language that the computer program is written in can be used in act 302. Additional information on GCC is available from the GCC steering committee, and on the Internet at “gcc.gnu.org”.

One of the identified functions is then selected (act 304). This selection can be performed in any of a variety of manners, such as in order of appearance in the program, in a random order, and so forth. One or more elements in the selected function are then identified (act 306). Given the tree data structure generated in act 302, the elements of the selected function can be readily identified. The elements of the selected function refer to all the commands, variables, constants, function or procedure calls, and so forth in the function. Although all of the elements of the selected function can be identified in act 306, alternatively in certain embodiments only particular elements are identified in act 306.

Programming languages typically include one or more keywords that are reserved. For example, “int” is reserved in the C++ programming language. These reserved words cannot be used as variables in the program. In certain embodiments, any elements that are declarations of variables using a reserved keyword are not identified in act 306. However, any element that uses such a variable would be identified in act 306. For example, an element in which a variable is declared to be of type “int” would not be identified in act 306, but an element in which that variable is used as a parameter of a function call would be identified in act 306.

Additionally, it should be noted that the same programming rule involving local variables may use different variable names in different segments of the program. In order to account for these differences, in certain embodiments the variable type is the element identified in act 306 rather than the variable name itself. By using the variable type rather than the variable name, programming rules can still be extracted from different functions even though the local variable names may differ.

The identified elements are then modified as appropriate (act 308). The identified elements are modified in act 308 to account for problems that may occur as the result of duplicate names for different types of identifiers. For example, a program may have a function name “lock” and also a variable type “lock”. When extracting programming rules, this function name and variable type should be treated as separate elements. However, these duplicate names would be hashed to a same value (as discussed in more detail below), which should be avoided as they should be treated as separate elements.

In act 308, element names are modified to account for this possibility of duplicate names. In certain embodiments, a prefix is added to every name that indicates the data type of the name. For example, all function names may have the prefix “F-” added to them, while all global variables may have the prefix “G-” added to them. Thus, the function call to “lock” would be modified in act 308 to be the name “F-lock”, while the global variable “lock” would be modified in act 308 to be the name “G-lock”.

These prefixes are one example of how names can be modified. It is to be appreciated that the names can be modified in any of a variety of other manners that allow duplicate names for different data types to be distinguished from one another. For example, different prefixes may be used, a suffix may be used rather than a prefix, and so forth.

In addition to duplicate names for different data types, different data structures may use the same names for their fields. For example, the names “next” and “prev” may be commonly used as field names in multiple different data structures in the same program. These duplicate names could result in errors when extracting programming rules, so names in data structures are modified in act 308 to prevent such errors from occurring. In certain embodiments, the names in data structures are modified to include the associated data structure type to every field name. For example, if two data structures of type “tree” and “list” each had a field “next”, and the preface “D-” is to be added for data structure types and the prefix “R-” is to be added for fields in a data structure, the “next” fields in those data structures would be modified in act 308 to be “D-tree.R-next” and “D-list.R-next”, respectively.

The adding of the associated data structure type to the fields names is one example of how names can be modified. It is to be appreciated that the names can be modified in any of a variety of other manners that allow these duplicate names in different data structures to be distinguished from one another. For example, different prefixes other than the data structure type may be used, the data structure type may be included as a suffix rather than a prefix, and so forth.

Hash values for the selected function are then generated by hashing the identified elements from act 306 as modified in act 308 (act 310). A hash algorithm is used on each of the elements to generate the hash value for that element. Any of a variety of different hash algorithms can be used. In certain embodiments, the hash algorithm “hashpjw” is used in act 310. Additional information on “hashpjw” can be found in “Compilers: principles, techniques, and tools”, by A. V. Aho, R. Sethi, and J. D. Ullman (1986).

In alternate embodiments, other numeric values rather than hash values can be assigned to the elements in act 310. For example, unique values can be identified rather than hash values. Unique values can be identified, for example, by first identifying all elements in all functions in act 308, and then assigning a different value to each of those different elements.

An indication of the element corresponding to the hash value or other numeric value assigned in act 310 is also maintained. Maintaining this correspondence allows the element corresponding to a particular numeric value to be subsequently identified, and further allows the function that the element is part of to be subsequently identified.

An itemset is then generated for the selected function from the hash values generated in act 310 (act 312). This itemset is the set of hash values of all of the identified elements, as modified as discussed above, in the function. In certain embodiments, duplicate hash values are not included in an itemset. For example, if a function includes multiple identified elements that hash to the same hash value, that hash value is included in the itemset only once. In alternate embodiments, these duplicate hash values are included in the itemsets.

Acts 304-312 are repeated for each function in the program (act 314). Once all functions in the program have been selected and itemsets for the functions generated, the itemset generation process is finished (act 316).

Table I illustrates an example function “twa probe” that is converted into an itemset. Additional code may be included in this example function, but has not been illustrated in order to simplify the example. The portions of the code corresponding to the identified elements in act 306 are shown in Table I in italics.

TABLE I

```
int_devinit twa_probe(struct pci_dev *pdev,...)
{
  struct Scsi_Host *host = NULL;
. . . . . .
  host=scsi_host_alloc(&driver_template, ...)
. . . . . .
  retval=scsi_add_host(host, &pdev->dev);
. . . . . .
  scsi_scan_host(host);
. . . . . .
}
```

For the code “struct Scsi_Host *host=NULL;”, a modified element of “T-Scsi_Host” is identified, which hashes to a value of 92. For ease of explanation, the hash values used in this example are only the last two digits of the calculated hash value. For the code “host=scsi_host_alloc(&driver_template, . . . )”, modified elements of “T-Scsi_Host F-scsi_host_alloc T-scsi_host template” are identified, which hash to the values 92, 39, and 41, respectively. For the code “retval=scsi_add host(host, &pdev->dev);”, modified elements of “F-scsi_add_host T-Scsi_Host T-pci_dev.R-dev” are identified, which hash to the values 68, 92, 56, respectively. For the code “scsi_scan_host(host);”, modified elements of “F-scsi_scan_host T-Scsi_Host” are identified, which hash to the values of 36 and 92, respectively. The resultant itemset for the code in Table I is {92, 39, 41, 68, 56, 36}.

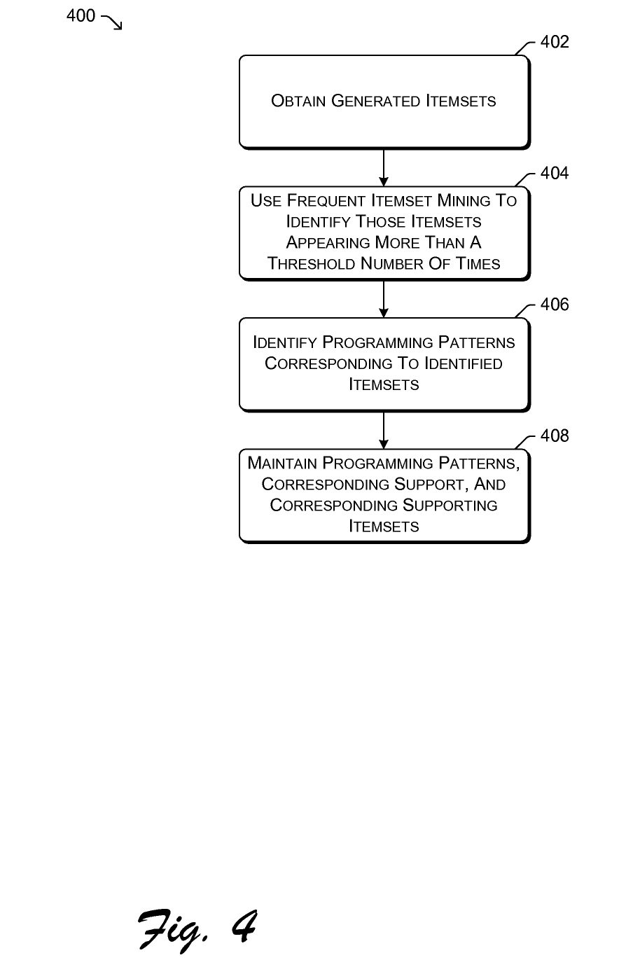

Returning to FIG. 2, the itemsets are generated in act 204 to allow programming patterns to be more easily identified. FIG. 4 is a flowchart illustrating an example process 400 for analyzing the itemsets to identify programming patterns. Process 400 illustrates an example of the analyzing of act 206 of FIG. 2 in additional detail. Process 400 is implemented by programming rule extractor 102 of FIG. 1, and may be performed in software, firmware, hardware, or combinations thereof.

Initially, the itemsets generated in act 204 of FIG. 2 are obtained (act 402). Using these obtained itemsets, frequent itemset mining is performed to identify those itemsets that appear more than a threshold number of times (act 404). Any of a variety of different data mining techniques can be used to identify those itemsets appearing more than a threshold number of times. In certain embodiments, a frequent itemset mining algorithm referred to as “FPclose” is used to perform the frequent itemset mining. Additional information regarding the FPclose algorithm can be found in “Efficiently using prefix-trees in mining frequent itemsets”, by G. Grahne and J. Zhu, in Proc. of the 1st IEEE ICDM Workshop on Frequent Itemset Mining Implementations, (2003).

Frequent itemset mining finds frequent itemsets in a database, which can be very large, where an itemset is a set of items. In a database composed of a large number of itemsets, if a sub-itemset (a subset of an itemset) is contained in more than a specified threshold number (referred to as min support) of itemsets, it is considered frequent. The number of occurrences of a sub-itemset A is referred to as the support of the sub-itemset. The itemset that contains A is referred to as the supporting itemset of the itemset A. For example, in an itemset database D, where D={{a, b, c, d, e}, {a, b, d, e, f}, {a, b, d, g}, {a, c, h, i}}, the support of sub-itemset {a, b, d} is 3, and its supporting itemsets are {a, b, c, d, e}, {a, b, d, e, f} and {a, b, d, g}. If min support is specified as 3, the frequent sub-itemsets for D are {a}:4, {b}:3, {d}:3, {a, b}:3, {a, d}:3, {b, d}:3 and {a, b, d}:3, where the numbers are the supports of the corresponding sub-itemsets.

Using the FPclose algorithm, instead of generating the complete set of frequent sub-itemsets, FPclose mines only the closed sub-itemsets. A closed sub-itemset is a sub-itemset whose support is different from that of its super-itemsets. In the preceding example, the frequent sub-itemsets {b}, {d}, {a, b}, {a, d} and {b, d} are not closed since their supports are the same as their super-itemset {a, b, d}. FPclose only generates the closed sub-itemsets {a}:4 and {a, b, d}:3 as a result. This can significantly improve time and space performance since it can avoid generating an exponential number of frequent sub-itemsets.

The itemsets appearing more than a threshold number of times identified in act 404 correspond to programming patterns and are identified as such (act 406). The programming patterns are patterns of elements that occur frequently (greater than the threshold number of times) within functions of the computer program. These programming patterns are used to generate programming rules, as discussed in more detail below.

The threshold number used in act 404 can vary. In certain embodiments, the threshold number is a parameter that can be set by a user of the system. The threshold number to use can be determined, for example, based on the size of the computer program (typically, larger computer programs can have higher threshold numbers), and based on the desires of the user (e.g., higher threshold numbers typically result in fewer programming patterns, whereas lower threshold numbers typically result in more programming patterns).

Referring to the example shown in Table I above, for simplicity these three functions are referred to as “add”, “alloc”, and “scan”. Assume that the sub-itemset {39, 68, 36, 92} appears in a total of 27 itemsets in the itemset database converted from the computer program from which the example is taken. Further assume that min support is set at 15. FPclose finds a frequent sub-itemset {39, 68, 36, 92} with a support of 27, which means that the corresponding functions alloc, add, and scan, and the data type Scsi_Host are used together 27 times. Therefore, these four elements are correlated with each other and are identified as a programming pattern.

Since FPclose generates only closed frequent itemsets whose support is larger than the support of its super-itemset, it does not generate redundant sub-patterns with the same support. In the preceding example, {39, 68, 36} is also a frequent sub-itemset. However, since {39, 68, 36} is not closed, (i.e., it is included in its super-itemset {39, 68, 36, 92} with the same support 27), it is not identified as a programming pattern.

Once identified, an indication of the programming patterns, their corresponding supports, and their corresponding supporting itemsets are maintained (act 408). The support and supporting itemset corresponding to each programming pattern are accessible to the FPclose algorithm, and thus can be maintained for later use. In the preceding example, for the closed frequent sub-itemset {39, 68, 36, 92}, that programming pattern as well as the support (27) and the supporting itemset that corresponds to the 27 functions that contain that programming pattern are maintained.

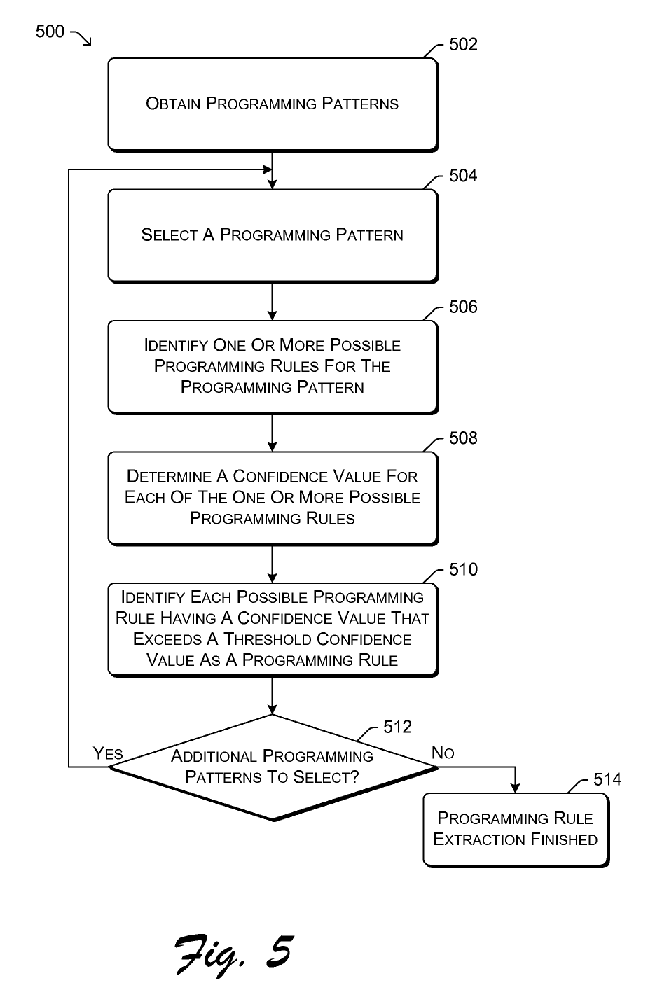

Returning to FIG. 2, the programming patterns are generated in act 206 to facilitate generation of the programming rules. FIG. 5 is a flowchart illustrating an example process 500 for generating programming rules from the programming patterns. Process 500 illustrates an example of the generating of act 208 of FIG. 2 in additional detail. Process 500 is implemented by programming rule extractor 102 of FIG. 1, and may be performed in software, firmware, hardware, or combinations thereof.

Initially, the programming patterns are obtained (act 502) and one of the programming patterns is selected (act 504). The programming patterns can be selected in any order, such as randomly, according to the order in which they were identified, according to the number of values in their itemsets, and so forth. One or more possible programming rules are then identified for the selected programming pattern (act 506), and a confidence value for each of the one or more possible programming rules is determined (act 508).

In certain embodiments, programming rules are generated by dividing the items in each closed frequent sub-itemset into two parts, and then calculating the confidence value. In other words, from a closed frequent sub-itemset I, the confidence for every possible programming rule X [symbol] Y is computed, where X and Y are subsets of I. The support of such a rule is equal to the support of I, while the confidence of such a rule is the conditional probability, i.e. support(I)/support(X), where support(X) is the number of occurrences of sub-itemset X in the itemset database, which also equals the maximum support of any closed frequent itemset that contains X. Basically, the confidence indicates the conditional probability that if X occurs, the likelihood for Y to occur.

Referring again to the example above, assume that a programming pattern {alloc, add, scan, Scsi_Host} is identified. From this pattern, fourteen different possible rules can be generated by partitioning these three functions and the data type into two subsets in all possible ways, such as {add}=>{alloc, scan, Scsi_Host}, and {add, alloc}=>{scan, Scsi_Host}, and so forth. All these rules have the support of 27. From the programming patterns discovered by FPclose, it is known that the support for {add} is 37, and the support for {add, alloc} is 29. Therefore, the confidence values for these two rules are 27/37=72.9% and 27/29=93.1%, respectively. The confidence values for the other twelve rules can also be computed similarly.

One problem with this approach is that it examines all possible rules from each mined programming pattern. A programming pattern with k elements can generate up to (2^{k}-2) rules, which can become inefficient with respect to both time and storage space requirements.

In other embodiments, different approaches are used in acts 506 and 508 so that all possible rules from each mined programming pattern are not examined. Rather, only closed rules are examined since other rules are subsumed by the closed rules. To further reduce the number of outputted rules and speed up the extraction (as well as the bug detection process discussed in more detail below), in certain embodiments closed rules are stored in a condensed format. The condensed format for a closed frequent sub-itemset I is:

I:s|{C₁:s₁>s} . . . {Cₘ:sₘ|sₘ>s}

In the condensed format, C₁ . . . Cₘ are all subsets of I whose supports (s₁ . . . sₘ) are different from I's, and s₁ . . . sₘ are all larger than s. This condensed format can represent all the closed rules derived from I and their confidences can be computed easily. For a closed rule X [symbol] Y derived from I, if X equals Cᵢ (i.e., a subset of I with a support larger than I), the confidence of the rule is s/sᵢ; otherwise, the confidence of the rule is 100%. For example, suppose FPclose extracts two closed frequent subitemsets, {a}:4 and {a, b, d}:3. The condensed format that represents all the closed rules derived from {a, b, d} is {a, b, d}:3|{a:4}. This explicitly expresses that the rule {a [symbol] b, d} has confidence ¾=75%, and also infers that any of the other five closed rules, such as {a, b [symbol] d}, has confidence 100%.

With this condensed format, the rule generation problem becomes how to find out all of the subset Cᵢ that have a support sᵢ larger than s. Since the support of Cᵢ is larger than s, it indicates that Cᵢ should be contained in another closed frequent sub-itemset (based on the definition of closed frequent sub-itemset). Since Cᵢ may be included in multiple other closed frequent sub-itemsets, the process finds the one frequent sub-itemset with the maximum support. To find this one frequent sub-itemset, the process converts this problem back to a frequent sub-itemset mining again. In other words, the process uses FPclose one more time to find common sub-itemsets from frequent sub-itemsets generated by the first pass of FPclose. Doing such finds all common subsets among the closed frequent sub-itemsets generated in the first pass. Assume that CommonSub denotes all the common subsets generated by the second pass of FPclose. If a subset Cᵢ of I is included in CommonSub, the process can immediately find out which super-itemset of Cᵢ has the maximum support. The support of this super-itemset is equal to the support of Cᵢ based on the definition of closed frequent sub-itemsets. It should be noted that the basic operation the process uses is to compute the common subsets for each pair of the closed frequent sub-itemsets. Therefore, the process applies the frequent itemset mining algorithm again on the closed frequent sub-itemsets with minimum support of 2.

An algorithm ClosedRules for generating closed rules in condensed format is shown in Table II. The ClosedRules algorithm in Table II generates closed rules R in condensed format from closed frequent itemsets Γ mined from the first step pass of FPclose. The FPclose algorithm takes an itemset database and the minimum support threshold as input, and outputs the closed frequent sub-itemsets, each of which has three fields <Fᵢ, sᵢ, Eᵢ>, where Fᵢ is the frequent itemset itself, sᵢ is its support, Eᵢ is the indexes of its supporting itemsets, and Eᵢ is sorted in an ascending order. Similarly, <F′ᵢ,s′ᵢ,E′ᵢ>have the same meanings but are generated by the second pass of FPclose (line 2) to a database that consists of all closed frequent sub-itemsets, i.e. {Fᵢ|i=1, 2, . . . ; n}.

TABLE II

| | Algorithm: ClosedRules(Γ) |
|---|---|
| | Input: Γ={Iₖ\|1 ≦ k ≦ n}, |
| | Iₖ has 3 fields <Fₖ, Sₖ, Eₖ>; |
| | Output: The closed rules R in condensed format |
| 1: | Sort Γ by supports in descending order such that S₁ ≧ S₂ ≧ ... ≧ Sₙ |
| 2: | Mine common closed frequent sub-itemsets from Γ: |
| | Θ←FPclose({Fᵢ\|i = 1, 2, ..., n},2), |
| | Where Θ={Cᵢ\|1 ≦ i ≦ m} and |
| | Cᵢ has 3 fields <F′ᵢ, S′ᵢ, E′ᵢ> |
| 3: | for i = 1, 2, ..., m |
| 4: | Denote E′ᵢ = {iⱼ\|1 ≦ j ≦ S′ᵢ |
| 5: | for j = 2, 3, ..., S′ᵢ |
| 6: | if sᵢ_{₁} > Sᵢ_{ⱼ} |
| 7: | Insert F′ᵢ : Sᵢ_{₁} to sub-itemset Iᵢ_{ⱼ} in R |

The ClosedRules algorithm in Table II first sorts the frequent itemsets Γ mined from FPclose (line 1) so that it can quickly locate the frequent itemset with the maximal support for any common subitemset. In line 2, it calls FPclose with minimum support of 2 to find out all common sub-itemsets C from Γ. For each common subitemset Cᵢ (line 3), ClosedRules inserts the subitemset with its support to the corresponding rule of condensed format as follows. E′ᵢ includes the indexes of all Cᵢ's supporting itemsets in Γ. The first supporting itemset Iᵢ_{₁} has the maximum support for Cᵢ, because all indexes in E′ᵢ are sorted based on their corresponding itemset's support. For the other supporting itemset Iᵢ_{ⱼ} (line 5), if its support sᵢ_{ⱼ} is smaller than sᵢ_{₁} (line 6), Cᵢ is inserted into the subset of the rule for the closed frequent itemset Iᵢ_{ⱼ}. This way, with only one pass the ClosedRules algorithm can insert Cᵢ into all rules that are super-itemsets of Cᵢ but have smaller support than Cᵢ.

It should be noted that the ClosedRules algorithm does not need to examine all possible rules generated from extracted programming patterns. By calling ClosedRules on the closed frequent sub-itemsets that correspond to the extracted programming patterns, the process obtains the closed rules in the condensed format expressed in numbers, and then it maps the closed rules back to programming rules and stores them into a specification file (e.g., as the output programming rules 108 of FIG. 1).

Each possible programming rule identified in act 506 having a confidence value that exceeds a threshold confidence value is identified as a programming rule (act 510). In certain implementations a threshold confidence value of 90% is used in act 510, although different implementations can use different threshold confidence values. Higher threshold confidence values result in sets of programming rules with fewer erroneous rules, but may also leave out possible programming rules that would be included with lower threshold confidence values. Any programming rules that do not have a confidence value that exceeds the threshold confidence value are pruned—they are not identified as programming rules by the system (e.g., they are not included as programming rules 108 in FIG. 1).

Acts 504-510 are repeated for each identified programming pattern (act 512). Once all identified programming patterns have been selected and programming rules identified, the programming rule extraction process is finished (act 514).

It should also be noted that the programming rules output by program rule extractor 102 of FIG. 1 can optionally be ranked in accordance with different schemes. For example, rules with larger supports may be viewed as more believable, and therefore rules with larger supports may be ranked higher than those with lower supports. By way of another example, different elements in the itemsets may be assigned different weights, and the rules can be ranked based on the weights of the elements they include (e.g., rules with heavier weighted elements may be ranked higher than those with lower weighted elements). Such rankings can be used, for example, to allow programmers or other users to see which rules are believed to be most important or most believable.

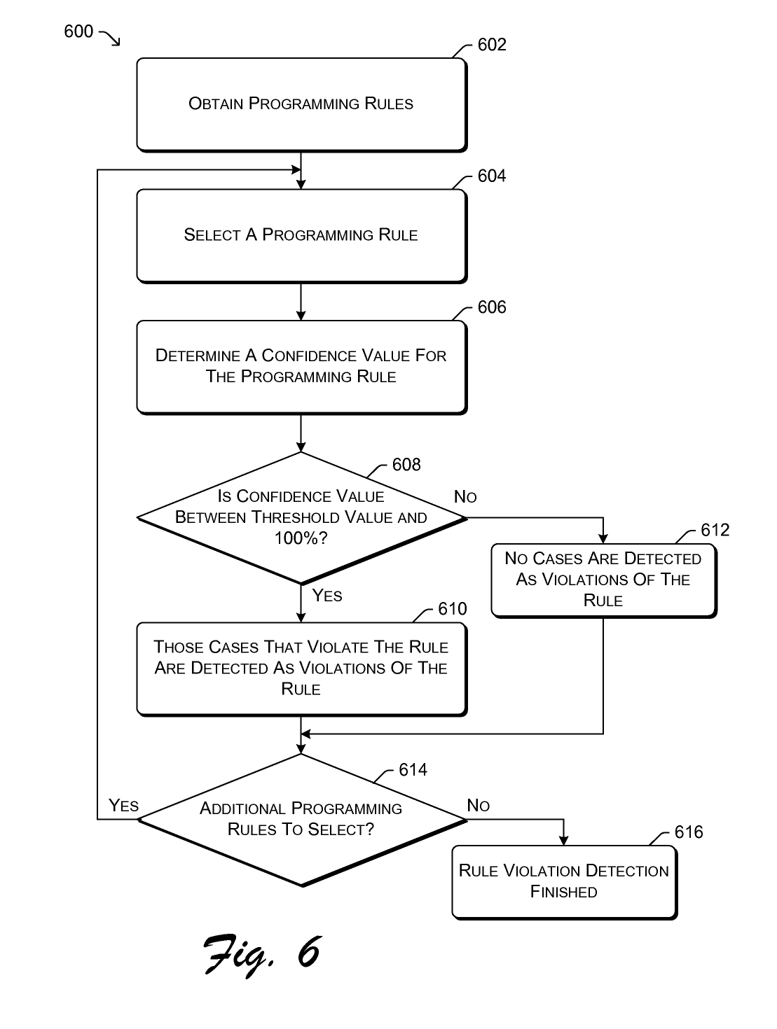

FIG. 6 is a flowchart illustrating an example process 600 for detecting violations of programming rules. Process 600 illustrates an example of the detecting of act 212 of FIG. 2 in additional detail. Process 600 is implemented by a potential bug detector 104 of FIG. 1, and may be performed in software, firmware, hardware, or combinations thereof.

Initially, the programming rules are obtained (act 602) and one of the programming rules is selected (act 604). These programming rules are those generated by programming rule extractor 102 of FIG. 1 as discussed above. The programming rules can be selected in any order, such as randomly, according to their rankings, according to their supports, and so forth.

In certain embodiments, all possible programming rules identified by programming rule extractor 102 based on the programming patterns discussed above are obtained in act 602 (e.g., all possible programming rules as identified in act 506 of FIG. 5). In such embodiments, all possible programming rules regardless of their confidence values are obtained in act 602.

In alternate embodiments, only those programming rules that have a confidence value that exceeds a threshold value are obtained in act 602. For example, these programming rules are the programming rules that are output as the extracted programming rules by programming rule extractor 102 (e.g., as identified in act 510 of FIG. 5).

A confidence value for the rule is then determined (act 606). This confidence value is the same confidence value as determined in act 508 of FIG. 5. In certain embodiments, the confidence value determined in act 508 of FIG. 5 is maintained and used in act 606 rather than re-calculating the value in act 606. This confidence value is obtained for a rule X [symbol] Y, where X and Y are subsets of I, as support(I)/support(X). For example, if a rule {a, b [symbol] d} has a support of 100, and {a, b} has a support of 101, then the confidence value of {a, b [symbol] d} is 100/101=99%.

A check is then made as to whether the confidence value is between a threshold value and 100% (act 608). This threshold value can have any of a variety of values, and in certain embodiments is the same threshold value as discussed above with respect to act 510 of FIG. 5. If the confidence value of the rule is below the threshold value, then there is not a strong enough belief that the rule is truly a rule and that any violations of that rule are present. Additionally, if the confidence value is 100%, then there are no violations of the rule. So, if the confidence value of the rule is between the threshold value and 100%, then those cases that violate the rule are detected as violations of the rule (act 610). An indication of the rule, as well as the function(s) in which the case(s) where the rule is violated appear, are maintained. However, if the confidence value of the rule is not between the threshold value and 100%, then no cases of the rule are detected as violations of the rule (act 612).

Acts 604-612 are repeated for each identified programming rule (act 614). Once all identified programming rules have been selected and violations detected, the programming rule violation detection process is finished (act 616).

In certain embodiments programming rules are stored in a condensed format as discussed above. Since the condensed format explicitly indicates which rules have confidence less than 100% but greater than the specified threshold t, those rules that have violations can be easily identified. Additionally, in embodiments using the ClosedRules algorithm discussed above to generate the programming rules, violations of programming rules can be detected during the same process. The confidence for the rule F′ᵢ [symbol] Fᵢ_{ⱼ}−F′ᵢ) in the loop of line 5 can be computed as c=sᵢ_{ⱼ}/sᵢ_{₁}. If t≦c<1, it indicates that there are violations to this rule. The violations can be easily figured out by comparing the supporting itemsets for the closed frequent sub-itemsets Iᵢ_{₁} and Iᵢ_{ⱼ} as follows. Fᵢ_{₁} contains the common sub-itemset F′ᵢ, but it does not contain (Fᵢ_{ⱼ}−F′ᵢ). This means that some supporting itemsets in Eᵢ_{₁} violate the rule F′ᵢ [symbol] Fᵢ_{ⱼ}−F′ᵢ). On the other hand, this rule is supported by the supporting itemsets Eᵢ_{ⱼ} for Fᵢ_{ⱼ}. Therefore, the itemsets in Eᵢ_{₁} but not in Eᵢ_{ⱼ} violate this rule, and so the corresponding functions of the itemsets violate the programming rule.

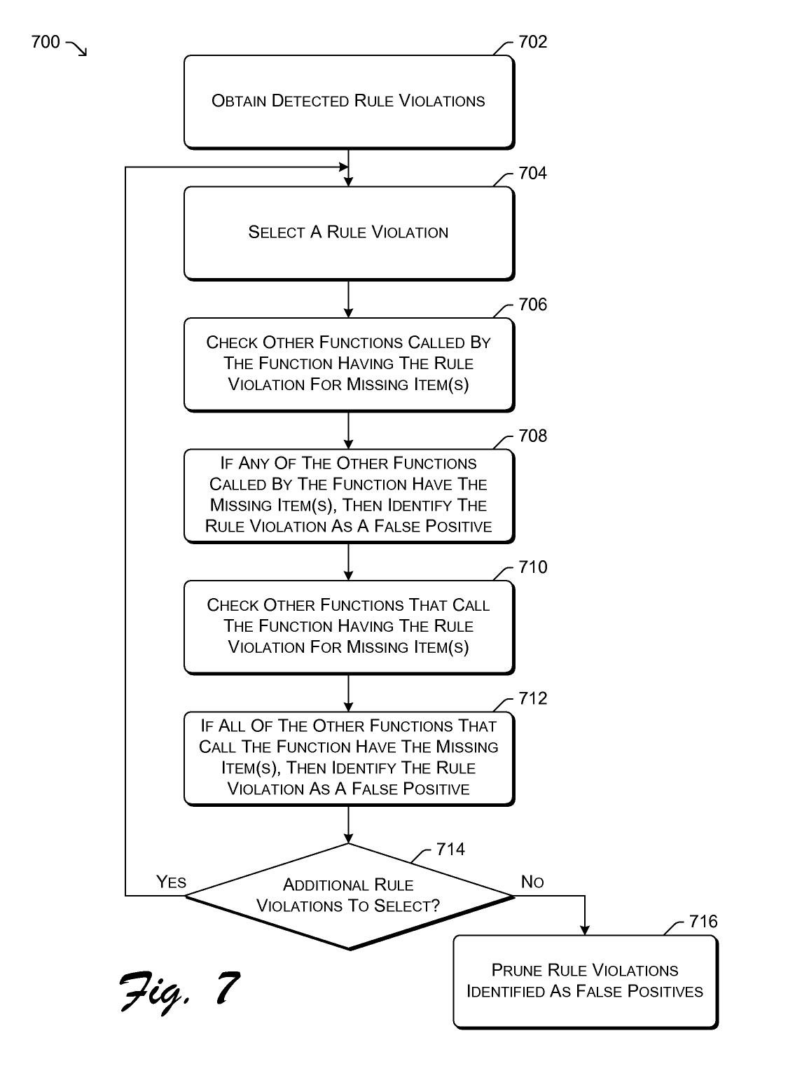

FIG. 7 is a flowchart illustrating an example process 700 for pruning false violations of programming rules. Process 700 illustrates an example of the pruning of false violations of act 214 of FIG. 2 in additional detail. Process 700 is implemented by a potential bug detector 104 of FIG. 1, and may be performed in software, firmware, hardware, or combinations thereof.

Situations can arise where a violation of a programming rule is detected but the items that are missing from the function in order to satisfy the programming rule are located in a different function that is called by, or that called, the function. For example, assume a rule that specifies a function having a call to “unlock” should also include a call to “lock”. Further assume that a particular function calls “unlock” but does not call “lock” directly; rather, the particular function calls a second function “try_lock” that calls “lock”. The particular function would initially be detected as having a violation because it does not call “lock”, but since the particular function calls “try_lock” which in turn calls “lock”, the rule is actually not violated. Therefore, that violation would be identified as a false positive. Following this example further, assume an additional rule that specifies a function having a call to “lock” should also include a call to “unlock”. The function “try_lock” would initially be detected as having a violation because it does not call “unlock”. However, if all functions which call “try_lock” do call “unlock”, then the rule is actually not violated, and that violation would be identified as a false positive.

Initially, the detected rule violations are obtained (act 702) and one of the rule violations is selected (act 704). These rule violations are those generated by programming rule extractor 102 of FIG. 1 as discussed above (e.g., as detected in act 212 of FIG. 2). The rule violations can be selected in any order, such as randomly, according to their rankings, and so forth.

The other functions that are called by the function having the rule violation are checked for the missing item(s) (act 706). These missing item(s) refer to the parts of the rule (the elements in the itemset) that were not found in the function and thus caused the violation of the rule to be identified. If at least one of the other functions that are called by the function having the rule violation include the missing item(s), then the rule violation is identified as a false positive (act 708). It should be noted that if multiple items are missing, then these multiple items may be found in the same or alternatively multiple different ones of the other functions (in other words, all of the missing items do not need to be found in the same other function).

It should also be noted that one or more of these other functions may also call one or more additional functions, which may in turn call further functions, and so forth. In certain embodiments, the depth of the function checking is limited. For example, the depth may be limited to a value of one (e.g., indicating that the other functions that are called by the function having the rule violation are checked for the missing item(s), but not any additional functions that are called by those other functions). By way of another example, the depth may be limited to a value of two (e.g., indicating that the other functions that are called by the function having the rule violation are checked for the missing item(s), and any additional functions that are called by those other functions are checked for the missing item(s), but that no further functions called by those additional functions are checked). In certain embodiments, the depth of the function checking is a parameter that can be set by a user of the system, balancing the desire for identifying false positives against the time required to perform the additional checks. Increasing the depth of the function checking can reduce the number of false positives, but at the expense of typically requiring additional time.

In addition to checking the other functions called by the function having the rule violation, other functions that call the function having the rule violation are also checked for the missing item(s) (act 710). If all of the other functions that call the function having the rule violation include all of the missing item(s), then the rule violation is identified as a false positive (act 712). The checking of other functions that call the function having the rule violation is typically limited to a depth of one, although alternatively this depth may be greater analogous to the discussion above regarding acts 706 and 708.

Acts 704-712 are repeated for each rule violation (act 714). Once all rule violations have been selected, the rule violations that were identified as false positives in acts 708 and 712 are pruned (act 716). In other words, the false positives are removed from the set of violations of the programming rules. As discussed above with respect to FIG. 2, this pruned set of violations of the programming rules can be output as the potential bugs 110 of FIG. 1, or alternatively this pruned set of violations of the programming rules may be ranked prior to being output as potential bugs 110 as discussed in more detail below.

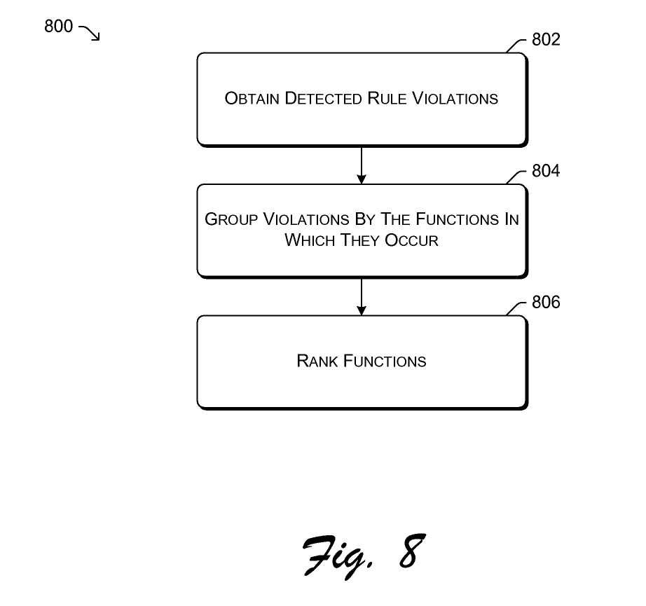

FIG. 8 is a flowchart illustrating an example process 800 for ranking the programming rules violations. Process 800 illustrates an example of the ranking of act 216 of FIG. 2 in additional detail. Process 800 is implemented by a potential bug detector 104 of FIG. 1, and may be performed in software, firmware, hardware, or combinations thereof.

Initially, the detected rule violations are obtained (act 802). The rule violations obtained in act 802 are the rule violations after the false positives have been removed (e.g., in act 214 of FIG. 2). A particular function can have violations of multiple different rules. For convenience, the rule violations obtained in act 802 are grouped together by function (act 804).

The functions are then ranked (act 806) according to one or more criteria. Different criteria can be used to rank the functions. In certain embodiments, the confidence values of all of the violations for the function are checked and the highest confidence value is selected and assigned as the confidence value for the function. The functions are then ranked according to their assigned confidence values. Other types of criteria can also be used in addition to or in place of this ranking. For example, correlation ranking may be used, functions may be ranked by the number of violations in the functions, and so forth.

Returning to FIG. 2, various modifications can also be made to the automatically extracting programming rules from a computer program and identifying potential bugs in the computer program of process 200. One such modification is to identify portions of the program that have been copied and pasted. Copying and pasting is often used by programmers to duplicate sections of code without having to rewrite the code. However, an error in a copied and pasted section can affect the results of the process 200 because the same error may be duplicated many times, which can result in process 200 missing reporting of the error. In certain embodiments, to account for this situation, sections of the program that are copied and pasted are identified and counted only once as an occurrence in the program. For example, if the particular code were copied and pasted 25 times, only 1 would count towards the support for that rule—the remaining 24 cases would be ignored (but may subsequently be identified as functions with potential bugs). Sections of the program that are copied and pasted can be identified in different manners, such as by using the CP-Miner discussed in “CP-Miner: A tool for finding copy-paste and related bugs in operating system code”, by Z. Li, S. Lu, S. Myagmar, and Y. Zhou, in Sixth Symp. on Operating Systems Design and Implementation (2004).

Macros are similar to copied and pasted code as macros are typically expanded and their code copied into the program. Thus, an error in the macro can be duplicated many times in the program analogous to copied and pasted code. As such duplications can affect the results of process 200, process 200 identifies macros and counts each only once analogous to copied and pasted code.

Additionally, in certain situations different functions within different modules or sections of the program can use the same name. Such situations can cause problems if process 200 is not able to distinguish between two different functions. In order to account for such situations, process 200 can use as the function names the entire path name of the functions—process 200 adds the name(s) of the module(s) in which the functions are located to the function names, thereby allowing process 200 to distinguish between the different functions.

Furthermore, in certain situations different control paths within a function may result in a programming rule being satisfied sometimes but not others. For example, an if-then-else statement may be included in a function, and if the “then” branch is taken then the programming rule is satisfied, but if the “else” branch is taken then the programming rule is violated. In order to account for such situations, process 200 can employ model checking (e.g., as used with compilers) to examine the multiple paths and evaluate each path for violation of the programming rules.

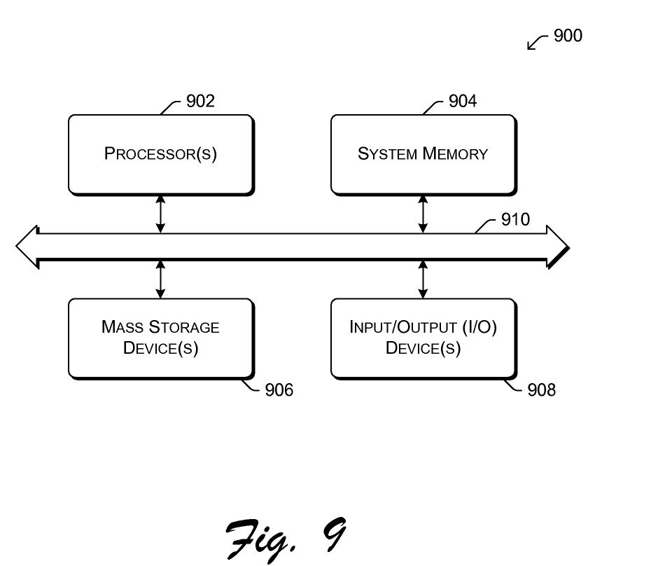

FIG. 9 is a block diagram illustrating an example computing device 900. Computing device 900 may be used to implement the various techniques and processes discussed herein. For example, computing device 900 may implement programming rule extraction system 100 of FIG. 1. By way of another example, any of the flowcharts of FIGS. 2-8 may be implemented by a processor(s) of computing device 900 executing instructions stored on one or more computer readable media. Computing device 900 can be any of a wide variety of computing devices, such as a desktop computer, a server computer, a handheld computer, a notebook computer, a personal digital assistant (PDA), an internet appliance, a game console, a set-top box, a cellular phone, a digital camera, audio and/or video players, audio and/or video recorders, and so forth.

Computing device 900 includes one or more processor(s) 902, system memory 904, mass storage device(s) 906, input/output (I/O) device(s) 908, and bus 910. Processor(s) 902 include one or more processors or controllers that execute instructions stored in system memory 904 and/or mass storage device(s) 906. Processor(s) 902 may also include computer readable media, such as cache memory.

System memory 904 includes various computer readable media, including volatile memory (such as random access memory (RAM)) and/or nonvolatile memory (such as read only memory (ROM)). System memory 904 may include rewritable ROM, such as Flash memory. System memory 904 includes removable and/or nonremovable media.

Mass storage device(s) 906 include various computer readable media, such as magnetic disks, optical disks, solid state memory (e.g., flash memory), and so forth. Various drives may also be included in mass storage device(s) 906 to enable reading from and/or writing to the various computer readable media. Mass storage device(s) 906 include removable media and/or nonremovable media.

I/O device(s) 908 include various devices that allow data and/or other information to be input to and/or output from computing device 900. Examples of I/O device(s) 908 include cursor control devices, keypads, microphones, monitors or other displays, speakers, printers, network interface cards, modems, lenses, CCDs or other image capture devices, and so forth.

Bus 910 allows processor(s) 902, system 904, mass storage device(s) 906, and I/O device(s) 908 to communicate with one another. Bus 910 can be one or more of multiple types of buses, such as a system bus, PCI bus, IEEE 1394 bus, USB bus, and so forth.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. One or more computer readable media having stored thereon a plurality of instructions to extract programming rules from a program, the plurality of instructions causing, when executed by one or more processors of a computer, the one or more processors to:
identify a plurality of portions of the program;
obtain a plurality of sets of numeric values by generating, for each of the plurality of portions, a set of numeric values that represents the portion;
analyze the plurality of sets of numeric values to identify programming patterns; and
generate, from the programming patterns, a plurality of programming rules.

2. One or more computer readable media as recited in claim 1, wherein to generate a set of numeric values that represents the portion is to generate, as the set of numeric values, a set of hash values by hashing elements of the portion.

3. One or more computer readable media as recited in claim 1, wherein each of the plurality of portions is a function of the program, and wherein to obtain the plurality of sets of numeric values is to, for each function:
identify one or more elements in the function;
modify particular ones of the one or more elements to generate one or more modified elements;
generate a hash value for each of the one or more modified elements; and
generate the set of numeric values by including, in a set of values, the generated hash values.

4. One or more computer readable media as recited in claim 3, wherein to modify the particular ones of the one or more elements is to add a prefix to each of the one or more elements, the prefix identifying a data type of the element.

5. One or more computer readable media as recited in claim 3, wherein to modify the particular ones of the one or more elements is to add, to each of the one or more elements that is a field name in a data structure, an indication of a type of the data structure.

6. One or more computer readable media as recited in claim 1, wherein to analyze the plurality of sets of numeric values is to use frequent itemset mining to identify sets of numeric values appearing more than a threshold number of times in the plurality of sets of numeric values, and identify programming patterns corresponding to the identified sets of numeric values.

7. One or more computer readable media as recited in claim 1, wherein to generate the plurality of programming rules is to:
identify each possible programming rule for each programming pattern;
determine a confidence value for each identified programming rule; and
include, in the plurality of programming rules, only those identified programming rules having a confidence value that exceeds a threshold confidence value.

8. One or more computer readable media as recited in claim 1, the plurality of instructions further causing the one or more processors to:
detect a plurality of violations of the plurality of programming rules; and
identify one or more of the plurality of violations as potential errors in the program.

9. One or more computer readable media having stored thereon a plurality of instructions to detect potential errors in a program, the plurality of instructions causing, when executed by one or more processors of a computer, the one or more processors to:
automatically identify a plurality of programming rules in the program;
detect a plurality of violations of the plurality of programming rules; and
identify one or more of the plurality of violations as potential errors in the program.

10. One or more computer readable media as recited in claim 9, the plurality of instructions further causing the one or more processors to:
detect one or more false violations in the plurality of violations;
remove the one or more false violations from the plurality of violations to obtain a plurality of potential errors; and
wherein to identify one or more of the plurality of violations as potential errors in the program is to identify the plurality of potential errors as the potential errors in the program.

11. One or more computer readable media as recited in claim 10, wherein to detect one or more false violations is to:
identify one or more missing elements of one of the plurality of programming rules that results in a violation of the programming rule;
check, for a function in the program that includes the violation, one or more additional functions in the program that are called by the function;
identify the violation in the function as a false violation if the one or more additional functions include the one or more missing elements.

12. One or more computer readable media as recited in claim 10, wherein to detect one or more false violations is to:
identify one or more missing elements of one of the plurality of programming rules that results in a violation of the programming rule;
check, for a function in the program that includes the violation, one or more additional functions in the program call the function;
identify the violation in the function as a false violation if each of the one or more additional functions includes all of the one or more missing elements.

13. One or more computer readable media as recited in claim 9, the plurality of instructions further causing the one or more processors to:
rank the errors of the plurality of potential errors based on confidence values of the programming rules that the plurality of potential errors violate; and
identify, in an order based on the rankings, the plurality of potential errors as potential errors in the program.

14. One or more computer readable media as recited in claim 9, the plurality of instructions further causing the one or more processors to:
group the plurality of violations by functions of the program;
identify, for each function that includes at least one of the plurality of violations, a confidence value for each programming rule that is violated by the function;
select a largest confidence value of the confidence values for the programming rules;
assign the selected confidence value to the function; and
rank the functions according to their assigned confidence values.

15. One or more computer readable media as recited in claim 9, wherein to detect the plurality of violations of the plurality of programming rules is to:
determine, for each of the plurality of programming rules, a confidence value for the programming rule;
determine whether the confidence value for the programming rule is between a threshold confidence value and 100%; and
if the confidence value for the programming rule is between the threshold confidence value and 100%, then detect those cases where the programming rule is violated as one of the plurality of violations, otherwise detect that the programming rule is not violated.

16. One or more computer readable media as recited in claim 9, wherein to automatically identify the plurality of programming rules is to:
identify a plurality of portions of the program;
obtain a plurality of sets of numeric values by generating, for each of the plurality of portions, a set of numeric values that represents the portion;
analyze the plurality of sets of numeric values to identify programming patterns; and
generate, from the programming patterns, the plurality of programming rules.

17. A method comprising:
identifying a plurality of portions of a program;
obtaining a plurality of sets of numeric values by generating, for each of the plurality of portions, a set of numeric values that represents the portion;
analyzing the plurality of sets of numeric values to identify programming patterns;
generating, from the programming patterns, a plurality of programming rules;
detecting a plurality of violations of the plurality of programming rules; and
identifying one or more of the plurality of violations as potential errors in the program.

18. A method as recited in claim 17, wherein each of the plurality of portions is a function of the program, and obtaining the plurality of sets of numeric values comprises, for each function:
identifying one or more elements in the function;
modifying particular ones of the one or more elements to generate one or more modified elements;
generating a hash value for each of the one or more modified elements; and
generating the set of numeric values by including, in a set of values, the generated hash values.

19. A method as recited in claim 17, wherein analyzing the plurality of sets of numeric values comprises:
using frequent itemset mining to identify sets of numeric values appearing more than a threshold number of times in the plurality of sets of numeric values; and
identifying programming patterns corresponding to the identified sets of numeric values.

20. A method as recited in claim 17, wherein generating the plurality of programming rules comprises:
identifying each possible programming rule for each programming pattern;
determining a confidence value for each identified programming rule; and
including, in the plurality of programming rules, only those identified programming rules having a confidence value that exceeds a threshold confidence value.

21. A method as recited in claim 17, further comprising:
detecting one or more false violations in the plurality of violations;
removing the one or more false violations from the plurality of violations to obtain a plurality of potential errors; and
wherein identifying one or more of the plurality of violations as potential errors in the program comprises identifying the plurality of potential errors as the potential errors in the program.

22. A method as recited in claim 17, further comprising:
ranking the errors of the plurality of potential errors based on confidence values of the programming rules that the plurality of potential errors violate; and
identifying, in an order based on the rankings, the plurality of potential errors as potential errors in the program.

23. A computing device comprising:
a processor; and
a memory, coupled to the processor, to store instructions to be executed by the processor in order to extract programming rules from a program by:
identifying a plurality of portions of the program;
obtaining a plurality of sets of values by generating, for each of the plurality of portions, a set of values that represents the portion;
analyzing the plurality of sets of values to identify programming patterns; and
generating, from the programming patterns, a plurality of programming rules.

24. A computing device as recited in claim 23, wherein each of the plurality of portions comprises a function of the program.

25. A computing device as recited in claim 23, wherein the instructions are further to be executed by the processor in order to detect potential errors in the program by:
detecting a plurality of violations of the plurality of programming rules;
detecting one or more false violations in the plurality of violations;
removing the one or more false violations from the plurality of violations to obtain a plurality of potential errors; and
identifying the plurality of potential errors as the potential errors in the program.

26. A computing device as recited in claim 23, wherein analyzing the plurality of sets of values comprises:
using frequent itemset mining to identify sets of values appearing more than a threshold number of times in the plurality of sets of values; and
identifying programming patterns corresponding to the identified sets of values.

27. A computing device as recited in claim 23, wherein generating the plurality of programming rules comprises:
identifying each possible programming rule for each programming pattern;
determining a confidence value for each identified programming rule; and
including, in the plurality of programming rules, only those identified programming rules having a confidence value that exceeds a threshold confidence value.
